(19) United States
(12) Patent Application Publication
(10) Pub. No.: US 2008/0195622 A1
(43) Pub. Date: Aug. 14, 2008

(54) Service provisioning system

(75) Inventors: Alon Lelcuk, Ramot Me'ir (IL); Michael Meller, Kfar Saba (IL); Avraham Rosenbach, Raanana (IL)

Correspondence Address: BROWDY AND NEIMARK, P.L.L.C.;624 NINTH STREET, NW, SUITE 300, WASHINGTON, DC, 20001-5303, US

(73) Assignee: Personeta Ltd., Hod Hasharon (IL)

(21) Appl. No.: 11/705,053

(22) Filed: Feb. 12, 2007

(51) Int. Cl. G06F 17/30

(52) U.S. Cl. 707/9; 707/E17.032

(57) ABSTRACT

A method for generating objects which facilitate access of application platform system and service provisioning system to a shared database. The method includes generating automatically objects for incorporating in the application platform system as well as objects for incorporating in the provisioning system. The generated objects facilitate access of the application platform system to the shared database, and further facilitate access of the service provisioning system to the shared database.

### FIELD OF THE INVENTION

This invention relates to a service provisioning system.

### BACKGROUND OF THE INVENTION

In the context of telecommunications systems, there are known Service Management Systems (SMS) (referred to occasionally also as Provisioning systems) which are typically (although not necessarily) the entire complex that consists of the Service Management Framework in the back end, and Web applications running on a Web server in the front end. The Service Management Framework (SMF) includes typically (although not necessarily) the set of applications that run on a dedicated application server and provide provisioning applications access to data.

Certain telecommunications systems further include a service delivery platform that serves as a real time component that provides real time services. An exemplary delivery platform system is disclosed in WO 04034273, “Method and Apparatus for a Service Integration System”.

Generally speaking, a service that is provided in real time by service delivery system may have associated data extracted from a database. The data is a priori fed to a database through a provisioning system. Although the provisioning varies greatly between different services, we can give a few illustrative examples:

Consider a voice service where the provisioning system could provide the announcements to be played, as well as their sequence, etc. These announcements will then be used by the service delivery part of the system, when the service is run. In accordance with yet another example, unified communication service is provided. The provisioning system may provide provisioning of email addresses, fax numbers, URLs and more. The service delivery system will then use this information to effect, for example, mail-to-fax conversion.

The provisioning system provides the infrastructure for e.g. identifying and authenticating users logging into the system, to ensure that changes are made only by authorized persons. In accordance with certain examples this infrastructure must also support multi-level hierarchies for managing customers, customer hierarchies, and “virtual operators” (MVNOs), all as known per se.

As is well known, existing service delivery platforms and more specifically traditional Intelligent Network/Advanced Intelligent Network Service Control Points (IN/AIN SCPs), rely heavily on complex and proprietary data management and data distribution systems. A driving factor in creating these systems is the need to keep large amounts of data available to transaction-intensive public grade networks. For example, a simple number translation service, such as 1-800 or a VPN service, may create data query loads on an order of magnitude of 10³ queries per second, with data segments as large as several gigabytes.

To cope with this extreme load, vendors and operators have adopted two main strategies:
Network partitioning (i.e. deploy several, identical SCPs with load sharing of traffic)
Proprietary, in-memory database technologies that keep data close to the SCP process.

However, complex provisioning systems are required to feed, synchronize and maintain multiple databases. Further, since proprietary, in-memory databases must be constantly tuned for performance, data integrity functions must be kept and enforced by the provisioning systems, thus greatly contributing to their complexity.

New demands from marketing—such as enhanced flexibility, faster time to market and Web self-provisioning—currently generate pressures to move from proprietary solutions to more open, mainstream technologies for creating the next generation of SMS. The effect is compounded by the need to replace outdated equipment with newer technologies.

As was demonstrated, a Service Management System is an essential companion to the real-time Service Delivery System for telecommunications services. Moreover, as more and more such real-time services are appearing on the market, there is a need to extend the Service Management System to support these newly emerging services. This is done for each new service by installing service-specific components into the Service Management System.

There is thus a need in the art to provide for a system and method for generating automatically various components which facilitate the operation of an overall telecommunications system.

### SUMMARY OF THE INVENTION

The present invention provides a method for generating objects which facilitate access of application platform system and service provisioning system to a shared database, comprising: generating substantially automatically at least one first object for incorporating in the application platform system; generating substantially automatically at least one second object for incorporating in the provisioning system; wherein said first objects facilitate access of the application platform system to the shared database; and wherein said second objects facilitate access of said service provisioning system to said shared database.

Further provided by the present invention, a telecommunications system for facilitating access of service delivery system and service provisioning system to a shared database, comprising: a generator for generating substantially automatically at least one first object for incorporating in a application platform system and at least one second object for incorporating in a provisioning system, whereby said first objects facilitate access of the application platform system to the shared database; and wherein said second objects facilitate access of said service provisioning system to said shared database.

Yet further provided by the present invention is a method for generating objects which facilitate access of service provisioning system to a database, comprising: generating substantially automatically at least one object for incorporating in the provisioning system, wherein said objects facilitate access of said service provisioning system to said shared database; providing a provisioning application for incorporation in the provisioning system; the provisioning application is configured to communicate through provisioning interface with a Web application running on a remote Web server, whereby the Web application is capable of accessing data in the database through the objects; generating substantially automatically a GUI associated with the Web application.

Further provided by the present invention is a method for generating objects which facilitate access of application platform system and service provisioning system to a shared database, comprising: generating substantially automatically at least one first object for incorporating in the application platform system; generating access means for incorporating in the provisioning system; wherein said first objects facilitate access of the application platform system to the shared database; and wherein said access means facilitate access of said service provisioning system to said shared database.

Further provided by the present invention is a method for generating objects which facilitate access of application platform system and service provisioning system to a shared database, comprising: generating substantially automatically at least one first object for incorporating in the provisioning system; generating access means for incorporating in the application platform system; wherein said first objects facilitate access of the provisioning system to the shared database; and wherein said access means facilitate access of said application platform system to said shared database.

Further provided by the present invention is a program storage device readable by a machine, tangibly embodying a program of instructions executable by the machine to perform method steps for generating objects which facilitate access of application platform system and service provisioning system to a shared database, comprising: generating substantially automatically at least one first object for incorporating in the application platform system; generating substantially automatically at least one second object for incorporating in the provisioning system; wherein said first objects facilitate access of the application platform system to the shared database; and wherein said second objects facilitate access of said service provisioning system to said shared database.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a generalized block diagram of a telecommunications system which utilizes the automatic generation of distinct components, in accordance with an embodiment of the invention;

FIG. 2 illustrates a block diagram of a run time component of the system of FIG. 1, in accordance with an embodiment of the invention;

FIG. 3 illustrates a sequence of operation of an automatic generation of components, in accordance with an embodiment of the invention; and

FIG. 4 illustrates a sequence of operation for generating Java Class representation, in accordance with an embodiment of the invention.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as, “generating”, “processing”, “computing”, “calculating”, “determining”, “accessing”, “communicating”, “enhancing” or the like, refer to the action and/or processes of a computer, or “system” such as “computing system” or “telecommunication system”, or processor, “or provisioning application” or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may use terms such as processor, computer, apparatus, system, sub-system, module, unit component and device (in single or plural form) for performing the operations herein. This may be specially constructed for the desired purposes, or it may comprise a general-purpose computer selectively activated or reconfigured by a computer program stored in the computer. Such a computer program may be stored in a computer readable storage medium, such as, but is not limited to, any type of disk including: optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes/devices (or counterpart terms specified above) and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

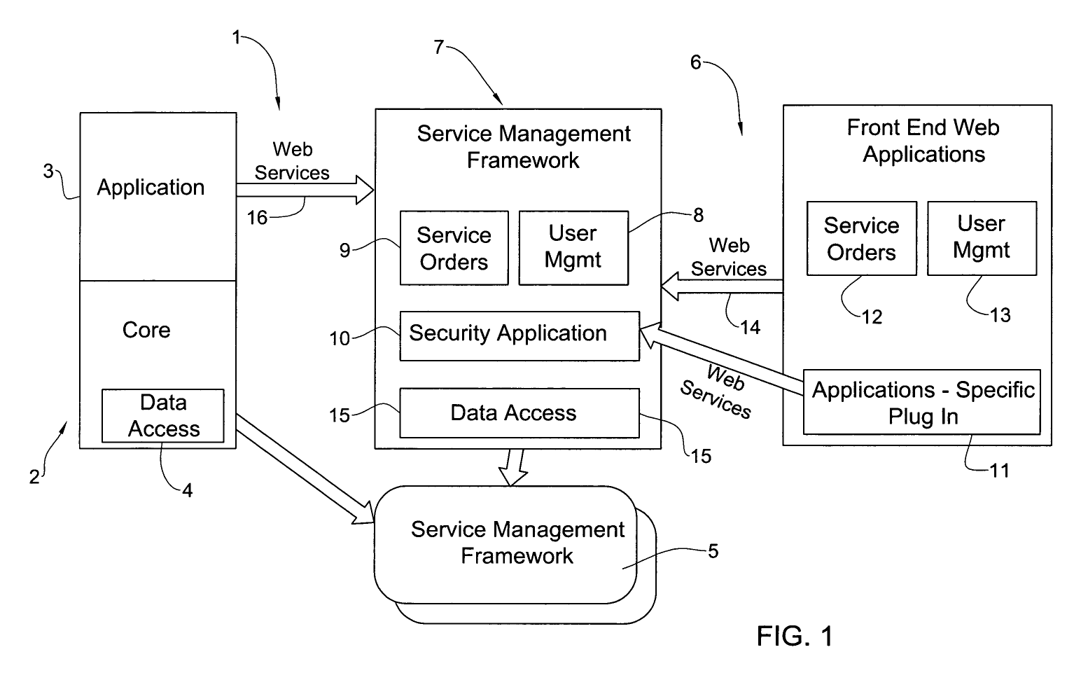

Bearing this in mind, attention is drawn to FIG. 1 illustrating a generalized block diagram of a telecommunications system which utilizes the automatic generation of distinct components, in accordance with an embodiment of the invention.

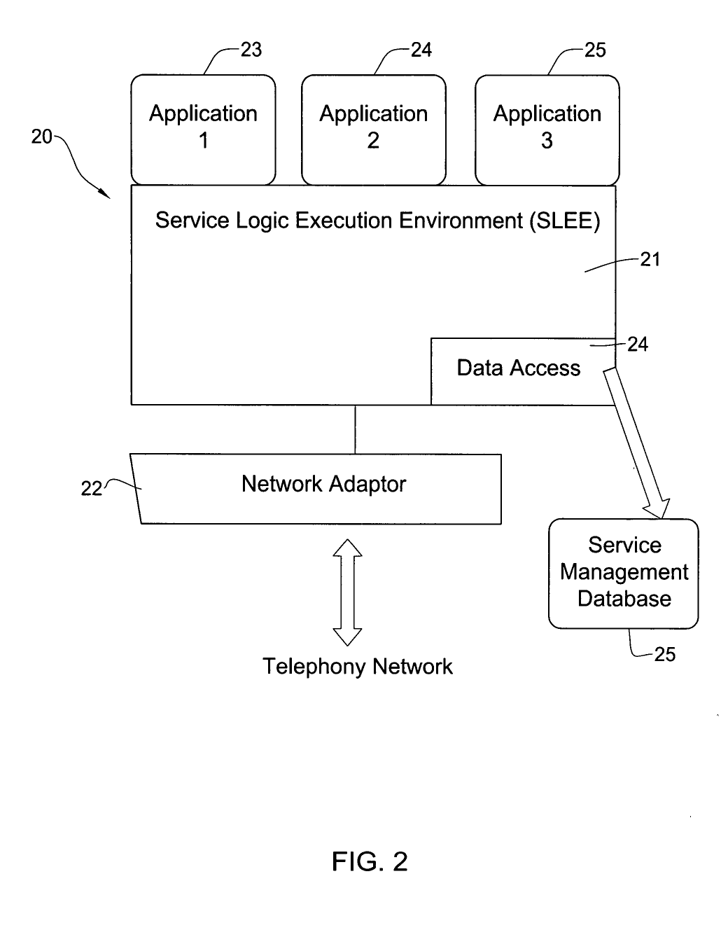

As shown, the architecture 1 includes a real-time part (application platform system, such as service delivery system 2) that includes an application layer and a core layer (as will be explained in greater detail with reference to FIG. 2).

The real-time service delivery platform 2 executes telecommunication services (at the application level 3), responding to real-time events arriving from the telecommunications network (not shown in FIG. 1). In many cases it needs to access data, e.g. specific parameters that relate to a given subscriber, and this is performed through data access module 4 that facilitate access to a database 5. The invention is not bound by any specific structure of database. A typical yet not exclusive example of using a real-time application includes: in a fax-to-mail service, the real-time application receives a fax; accesses the database in order to identify the subscriber (according to the fax number); it then accesses the database again, reading an Email address for the subscriber; then it forwards the image file containing the fax to that Email address. In a typical relational database (RDBMS) implementation, this would be organized as a single table (“relation”) named “USERS”, having several columns, including “FAXNUMBER” and “EMAILADDRESS”.

As will be explained in greater detail below, the data access includes objects which facilitate access to the data.

The objects are generated substantially automatically in accordance with certain embodiments of the invention, as will be explained in greater detail below. In accordance with certain embodiments the objects are of the Object Relational (O/R) mapping type. In accordance with certain embodiments the objects are of the Java Objects (JO) type. In accordance with certain embodiments, the objects are of the Java Data Objects (JDO) type which, as is known per se, provide a suite of tools and APIs that facilitate Java applications with object-oriented access to a database schema. In this connection, note that the high-level Java Data Objects (JDO) API is designed to provide a transparent interface for developers to store data, without having to learn a new data access language (such as SQL) for each type of persistent data storage. JDO enables developers to write Java code that transparently accesses the underlying data store, without using database-specific code. The two main objectives of the JDO architecture are to provide Java application developers a transparent Java technology-centric view of persistent information and to enable pluggable implementations of data stores into application servers.

Note that in accordance with certain embodiments, one or more objects that facilitate access to the shared database may be generated, all depending upon the particular application.

Note also that the invention is not bound by generation of object(s) in both the management and the provisioning system. Thus, as will be explained in greater detail below, in accordance with certain embodiments, object(s) are generated in either one of the application platform system 2 or service provisioning system 6.

Reverting now to FIG. 1, the data (e.g. user parameters, such as customer profile) were a priori fed to the database 5 using non real-time provisioning system 6 (referred to also collectively as Service Management System (SMS)). As shown, in accordance with certain embodiments, the Provisioning system includes a set of business-logic modules, implemented within the Service Management Framework (SMF) 7. In accordance with certain embodiments, these modules (exemplifying in a non-limiting manner Web services, that is, applications that present a programmatic interface using the SOAP protocol) take care of all other, non-presentation, aspects of service provisioning. For instance, this includes (i) validation of objects (e.g. subscriber details) being added, dependency rules when adding and removing subscribers and service orders (9), security enforcement (e.g. who is entitled to open an order 10), report generation and much more. If desired, the Web services are provided as plug-ins. Note that the SMF is of course not bound by the specified Web services which may vary, depending upon the particular application.

As further shown in FIG. 1, there is provided a front-end module that includes a series of Web applications (e.g. 12 and 13 that correspond to modules 8 and 9, at the SMF respectively), implemented e.g. on a commodity Web server (such as Microsoft IIS, or Apache). These applications are responsible for the presentation (“look”) of the provisioning user interface, through the Web. As will be explained in further detail below, these applications have a GUI part which is generated substantially automatically, in accordance with certain embodiments of the invention.

In accordance with certain embodiments, the interface between the front end 11 (the Web applications running on a Web server) and the Web services of the SMF 7 is defined by a WSDL schema 14. Note that in accordance with certain embodiments, in order to enable standard Web services (whether Java-based, Net based or otherwise) to access the SMF 7, the services are published as WSDL definitions, and can be accessed using the industry-standard SOAP protocol. SOAP as is well known is a Remote Procedure Call (RPC) infrastructure, where requests and responses are transported as XML documents over HTTP.

Reverting now to FIG. 1, the front-end system (11) can support a rich set of Web services (such as services which allow an application to control the service order process, management of users and subscribers, the actual configuration of the service for a particular subscriber, and others). The services may vary, depending upon the particular application.

Attention is now drawn to FIG. 2, illustrating a more detailed structure of a service delivery platform component 20, in accordance with an embodiment of the invention. A detailed structure of a service delivery platform is disclosed in US2006/129662, “Method and Apparatus for a Service Integration System”, which is incorporated herein by reference.

In accordance with certain embodiments, the service delivery platform 20 consists of one or more Service Logic Execution Environments (SLEEs) 21, and one or more Network Adaptors 22. There may be different types of Network Adaptors in the same system, if connection to multiple networks (e.g. IP and PSTN) is required.

Each of the SLEEs is capable of running multiple different applications (of which 23, 24 and 25 are shown in FIG. 2) and a plurality of application instances, each typically corresponding to a network session, e.g. a phone call. The shared database 25 can be accessed through data access module 24, using objects as described herein.

The invention is of course not bound by the specified architecture described with reference to FIGS. 1 and/or 2.

Bearing this in mind there follows a description of a sequence of operation utilizing the SMS and the run time service delivery platform. The sequence of operation will be exemplified with reference to a specific example. Consider, for example, a service in which a called party receives a telephone call from a calling party. In accordance with the propounded service, the telephone call is intercepted and the called party will be displayed with a photo of the calling party (say displayed on the screen of the called party's PC which is located at the vicinity of his/her landline telephone). If the called party approves, the call will be routed to the called party telephone device.

Bearing this service in mind, there follows a description of a provisioning sequence of operation. Thus, a user issues a command at the Web application running at the front-end module 11, in response a Web Form GUI is displayed and the user selects the desired service to enroll, and fills-in the relevant details, including provision of a photo. The Web application (running on a Web server 11) issues a SOAP request into the SMF 7 (using the WSDL interface 14). An SMF application receives this request, and appropriate Web service (not shown in FIG. 1) performs some logic tests (e.g. checks whether the photo data complies with a certain format, say JPG or BMP, ensures the photo is of the proper dimensions, etc.). Having checked and approved the data, the Web service accesses the shared database 5 using the objects, say JDO objects (forming part of the data access module 15). In accordance with certain embodiments, the JDO implementation uses JDBC (a Java SQL API) as a database schema to access the database and write the data (the subscriber details including the photo) in the shared database 5. By this specific example, the JDBC accesses the database, typically using a proprietary protocol, such as Oracle Net*8.

In this particular example, the specified subscription process is performed both by the caller and the called party.

Having fed the relevant input to the database (5), there follows a description of a sequence of operation during run time using the service delivery platform 2, in accordance with certain embodiments of the invention.

Thus, when executing a service (e.g., approve caller as discussed above), the following sequence takes place:

A call comes in from the network into the Network Adaptor (22). The Network Adaptor invokes the Service Logic Execution Environment (SLEE) (21). The SLEE selects which application should handle this call (of which three applications 23-25 are shown in FIG. 2), and creates an application instance of this type. In the latter example the relevant application is the one that implements the “approve caller” service. The application instance now needs to locate the subscriber profile corresponding to the call. In this particular case, this is the user receiving the call (in order to ascertain that the receiving party is subscribed to the service). The application calls the Data Access module, which has been previously extended with the data objects corresponding to the subscriber profile for this application. Note that by this example there is a general object class called, say “SubscriberProfile” and distinct class instances for each occurrence of this class (for defining each specific subscriber). The Data Access layer initiates a call into the database through the objects.

The data extracted from the database is fed to the application, which determines the exact sequence of operations for this call. In this particular case after having identified that the receiving party is subscribed to the “approve caller” service another data access is launched in order to obtain the pertinent data of the calling party, including her photo. The access to the database is performed in a similar manner using the JDO as described above. The data stored at the database further specifies the timeout duration for this service.

After having obtained the data of the calling party the application triggers a sequence of operations which leads to displaying the photo of the calling party at the PC of the called party (the latter data, i.e. where to display the photo is also extracted from the database), and if the called party provides an approval within the specified timeout, the call is routed to the designated landline of the called party, otherwise, (again in accordance with data extracted from the database) the call is handled in a prescribed manner (e.g. discarded, or routed to the voice mail of the receiving party, etc.).

Note that the specified data extracted from the shared database 5, at run time, was inserted to the shared database during the off line provisioning phase described above.

In accordance with certain embodiments, the SLEE accesses the database through an object such as JDO. Note that the invention is not bound by using JDO. Thus, in accordance with certain other embodiments, objects generated by any O/R mapping technology can be used, such as Java Objects. Other object types are also applicable.

Reverting now to the JDO, this allows the service code running on the SLEE, which by one example, is written in Java, to see the provisioned data as objects, instead of raw database records. This significantly simplifies the delivery service logic.

Generally speaking, in accordance with certain embodiments, the Service Delivery platform accesses service management information (stored in the shared database) in order to determine the behavior of the service. For example, in a call routing service, the sequence of numbers to call would be read from the shared database.

Having described a sequence of provisioning of data to a shared database using front end Web application and utilizing the data (extracted from the shared database) by means of the service delivery platform in accordance with certain embodiments of the invention, there follows a description of provisioning of data, in accordance with other embodiments of the invention. Thus, it is possible to provide provisioning service in an alternative route not necessarily using the Web application through the front end system 11. The alternative route would be to utilize the delivery system also for provisioning data applications. Thus, in accordance with certain embodiments, through a WSDL interface 16 (similar to interface 14) provisioning data input can be provided from the Delivery application level, e.g. using the telephone voice interface (and/or telephone keypad). The so fed inputs are processed by the appropriate Web Service application (incorporated in SMF 7) which processed data is fed to the shared database 5 through the objects of data access 15, thereby facilitating provisioning of data through the delivery system. Consider for instance a forward call service, where the subscriber needs to provide the list of telephone numbers to which the call should be routed. These provisioning data (e.g. list of routed telephone numbers) can be fed through the delivery system (rather than the Web application), in the manner specified above.

Note that the invention is not bound by the sequence of provisioning and/or runtime operations described above and a fortiori not by the specific “approve caller” or “forward call” service, which were provided for illustrative purposes only.

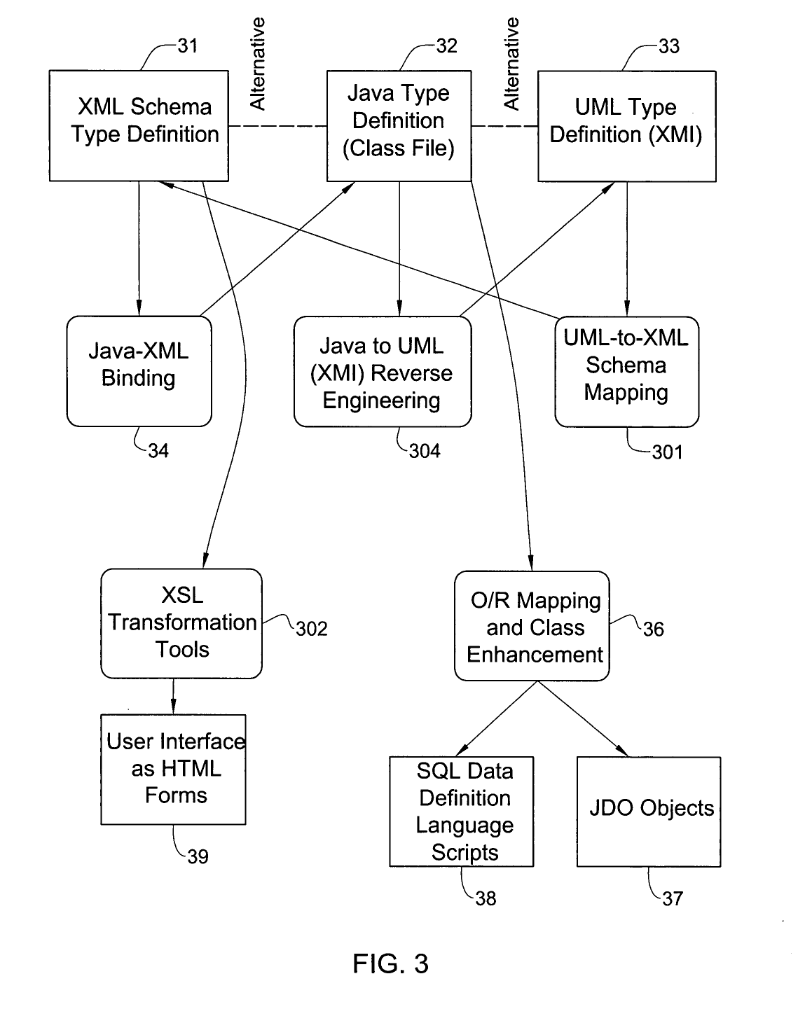

Having described structure and manner of operation of the system there follows a description with reference to FIG. 3, showing how certain components are generated substantially automatically, to facilitate the functionality described in a non-limiting manner above.

It should be noted that the automatic generation of object(s) may refer in accordance with certain embodiments to both the application platform system (2) and the provisioning system (6). In accordance with certain embodiments the automatic generation refers to only the platform system 2. By these embodiments the provisioning system 6 can access the shared database 5 by other means, say using SQL statements, using, say ODBC interface.

In accordance with certain embodiments the automatic generation refers to only the provisioning system 6. By these embodiments, the application platform system 2 can access the shared database 5 by other means, say using SQL statements, using, say ODBC interface. The description below refers in a non-limiting manner to automatic generation of objects for use in both the application platform and provisioning system.

Thus, in accordance with certain embodiments, there is provided an input which is fed to a system for generating, in substantially automatic fashion, objects which facilitate access of application platform system (such as service delivery platform 2 in FIG. 1) and service provisioning system (such as SMF 7 of FIG. 1) to a shared database (e.g. 5 of FIG. 1).

The input definitions can be provided in various forms, such as XML file (31). Note that in addition to (or instead of) XML Schema, other input types can be used to define the provisioning objects, thereby starting the “build” process. For example, Java (32) has good facilities for the definition of data types, and therefore Java (source or compiled) code can serve as input to this process. Unified Modeling Language (UML) (33) can also be used for this purpose.

Other variants of inputs are also applicable, depending upon the particular application.

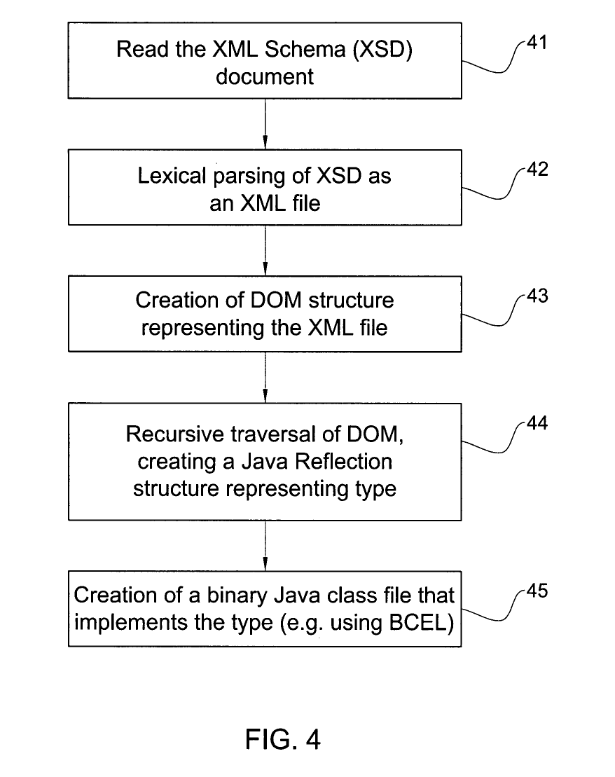

In accordance with certain embodiments, the XML type (31) definition, e.g. for defining the concept of a “user”, is transformed into an object class (32) through binding sequence (which will be described in greater detail with reference to FIG. 4). The transformation of XML Schema to Object Class (32) uses in accordance with certain embodiments the capabilities of the JAXB technology. JAXB is a Java technology that enables to generate Java classes from XML schemas by means of a JAXB binding compiler. The JAXB binding compiler takes XML schemas as an input, and then generates a package of Java classes that reflect the rules defined in the source schema. These generated classes are in turn compiled and combined with a set of common JAXB utility packages to provide a JAXB binding framework. The JAXB binding framework provides methods for unmarshalling XML instance documents into Java content trees—a hierarchy of Java data objects that represent the source XML data.

Note that JAVA class is an example of the object class.

The transformation of XML Schema to object class is also provided by Patent application US20050114394A1 “Mapping XML schema components to qualified Java components” by Kaipa, Sam P., Rahurkar, Ashish, Bollineni, Pradeep C. and Arora, Ashutosh.

The object class 32 is now processed into objects, e.g. JDO objects 37 which can be used by Java code for accessing the database. The transformation of object class into JDO is performed using enhancing processing 36. The JDO enhancer applies changes to the classes to make them persistence capable. The JDO Enhancer work is done by performing bytecode modifications on Java classes, therefore Java object code is not affected or changed by its operation. JDO Enhancer defines which classes to enhance, and which fields to make persistent and adds into each persistence capable class the additional methods required for setting and retrieving of attribute values by a JDO implementation. By default, all fields that are not declared final, static, or transient in the Java class become persistent. In accordance with certain embodiments, the Enhancer performs the following:

Adding implementation of a persistency Interface to the class definition;

Appending the implementations of persistence methods;

Adding accessor and mutator methods for the managed fields in the class;

Declaring additional specific fields required for the classes that implement the interface.

Direct accesses to persistent fields are replaced by method calls.

The enhancing operation described above would result in objects such as JDO objects. The enhancement (using, say known per se enhancer tool) adds code to the JAVA class (32) that facilitates access to the shared database. Note that the addition of code will facilitate accessing the database through the object, rather than accessing the database in a more conventional approach like SQL commands through JDBC API. For instance, consider a JAVA class “sub.profile”. Normally, if the field sub.profile.name is modified then this would cause only a change of the object in the memory. In contrast, in accordance with certain embodiments, the same modification would result in modifying the appropriate field in the database.

After having generated the JDO, 37, it can be incorporated in the service delivery platform 2 and facilitate access of the application platform system through the JDO to the shared database (5), as explained with reference to FIGS. 1 and 2, above.

In accordance with this embodiment the so generated JDO object can also (or instead) be incorporated in the provisioning system (say SMF 7) for facilitating access of the service provisioning system through the JDO object to the shared database, as explained with reference to FIGS. 1 and 2, above.

In accordance with the embodiment described with reference to FIG. 3, the so generated JDO serves for incorporation both in the delivery system and the provisioning system. Note that if the same object is incorporated in the delivery and the provisioning system, this may constitute an advantage including consistency of the so generated code, maintaining same libraries, etc. In accordance with certain other embodiments the objects that are generated for incorporation in the delivery system are different than those generated for incorporation in the provisioning system.

In accordance with certain embodiments other type of objects are generated, e.g. of Object Relational (O/R) mapping type, Java Objects, etc. The invention is not bound by the specified types.

In accordance with certain embodiments of the invention, a schema of the shared database is generated. Thus, by one embodiment, the Abstract object is converted further into an SQL Data Definition Language (DDL) script, which generates a physical database schema 38. This may be performed using for example the same known per se enhancer tool.

In accordance with certain embodiments, the schema of the database and the objects are generated substantially simultaneously.

As explained above, the input XML schema (31) is only an example of possible inputs. Thus, in accordance with another embodiment other forms of input can be used, say Java object Class 32. By this example the need to apply the binding operation 34 is obviated and accordingly the input 32 is subject to enhancement 36 (already described above) giving rise to the specified JDO and schema (37 and 38, respectively).

In accordance with another embodiment, another form of input is used, an XMI document being the formal representation of UML diagrams 33. This may require transformation into XML schema representation 31 using XML mapping tool 301 (Such mapping tools exist—for example Eclipse Modeling Framework, IBM Rational Rose, Velocity and Hyper Model. Possible mapping can be through the use of XMI and XSLT stylesheets). Note that the XML schema representation is similar to the input schema 31 described above. Accordingly the XML schema representation is subject to the binding sequence 34, which is later processed and enhanced 36 giving rise to the JDO and database schema (37 and 38, respectively).

The invention is not bound by the specified inputs.

In accordance with certain embodiments, a GUI part of Web applications (running, e.g. on the front-end 11) is generated substantially simultaneously.

Thus, in accordance with certain embodiments, the input definition, say XML type definition 31 can be transformed 302, using, by way of example, standard XSLT tools. Note that XSL Transformations defines an XML-based programming language designed for use as part of XSL, which is a stylesheet language for transforming XML documents into other text formats, specifically into HTML. Since XML schema is an XML document and transformation is to HTML, transformation is supported by XSLT. A transformation expressed in XSLT describes rules for transforming a source document tree into a result document tree. The transformation is achieved by associating patterns with templates. A pattern is matched against elements in the source tree. A template is instantiated to create part of the result tree.

By one example the GUI is represented by a simple HTML form 39 that defines the user interface for providing user input to the provisioning procedure. In accordance with certain embodiments these Web forms can be used as-is by carrier staff, and may be processed further, either automatically or manually, to create a branded Web site for service provisioning by the end customers.

The so automatically generated GUI can serve for provisioning of data to the shared database, as explained in detail with reference to FIGS. 1 and 2 above. Note that in the case of Java input 32 or UML input 33, they can be transformed to XML schema 31 using transformation tool (304). There are many tools performing Java reverse engineering and automatic generation of UML-standard class diagrams from Java source and export of model data to XMI-format. Some of the tools are: ESS-MODEL, Ideogramic UML, Jude Professional, Inovator).

Note that the invention is not bound by the specified GUI as HTML representation.

Attention is now drawn to FIG. 4, illustrating a sequence of operation for generating Java Class representation, in accordance with an embodiment of the invention. Thus, an input XML schema is provided (41) (see also 31 in FIG. 3) and is parsed to into XML file (42). Next a Document Object Module (DOM) structure is created for representing the XML file (43). Next, the DOM is recursively traversed for creating JAVA reflection structure representing data type (44) and finally a binary JAVA class file is created for implementing the data type. The net effect is generating JAVA class forming a non-limiting example of object class (see, e.g. 32 in FIG. 3). A non-limiting means of generating this object class as described with reference to FIG. 4, is using the Java Architecture for XML Binding (JAXB) technology.

It should be noted that the generation of object classes in general and JAVA classes in particular are by no means bound by the procedure described with reference to FIG. 4. Thus, in accordance with certain embodiments, a known per se Service Creation Environment (SCE) is utilized for generation of objects of the kind specified. Note that the SCE provides a convenient way to create services with complex service logic enabling built-in integration of service and service objects generation. In accordance with certain embodiments an XML editor inside the SCE is used to create a definition of the required data (the per subscriber provisioned data residing in the DB), and the procedures to store and administer the data are automatically generated. Once the service logic is tested the service can be packaged and deployed using the built-in zero downtime deployment tools.

In accordance with certain embodiments, it is possible to use the SCE for both generating service logic and service provisioning when developing services and applications that integrate Telephony, Internet, IT, or any other application or protocol for both generating service logic and service provisioning.

Bearing all this in mind, it should be noted that in accordance with certain embodiments the automatic generation of objects constitutes an advantage in the sense that the tedious manual effort of generating interface to access to the shared database from the delivery platform and from the provisioning system is obviated.

It should be further noted that in accordance with certain embodiments the automatic generation of database schema constitutes an advantage in the sense that the tedious manual effort of generating schema which facilitates access to the shared database from the delivery platform and from the provisioning system is obviated.

It should be further noted that in accordance with certain embodiments the automatic generation of GUI constitutes an advantage in the sense that the tedious manual effort of generating GUI which facilitates provisioning of data through the Web server is obviated.

The Service Management Framework provides an extensible infrastructure for user-written services. As can be seen in the example below, a general concept, that of a “user” is extended for a particular service by adding attributes of a user that are particular to that service.

Attention is now drawn to an illustrative example of an input code portions and output components that are fed into and generated by an automatic component generation method, in accordance with a specific embodiment of the invention. The invention is of course not bound by this example.

The following data definition input (see 31 of FIG. 3), given as an XML schema, is the information model that describes for instance a “user”.

```
<xsd:complexType name=“genericUserType”>
  <xsd:complexContent>
    <xsd:extension base=“cm:persistentElement”>
      <xsd:sequence>
        <xsd:element name=“userId” type=“cm:userIDType”/>
        <xsd:element name=“IDNumber” type=“cm:IDNumberType” minOccurs=“0”/>
        <xsd:element name=“name” type=“cm:userNameType” minOccurs=“0”/>
        <xsd:element name=“fax” type=“cm:telNumber” minOccurs=“0”/>
        <xsd:element name=“phone1” type=“cm:telNumber” minOccurs=“0”/>
        <xsd:element name=“phone2” type=“cm:telNumber” minOccurs=“0”/>
        <xsd:element name=“email” type=“cm:emailType” minOccurs=“0”/>
        <xsd:element name=“address” type=“cm:address” minOccurs=“0”/>
        <xsd:element name=“birth Date” type=“xsd:dateTime” minOccurs=“0”/>
        <xsd:element name=“gender” type=“xsd:string” minOccurs=“0”/>
      </xsd:sequence>
    </xsd:extension>
  </xsd:complexContent>
</xsd:complexType>
```

This data type, which is defined by the Framework, is now extended (still forming part of input 31) for the needs of a particular service. As per the “approve caller” service described above, the framework includes picture of subscriber, so called Unified messaging (see =“useUm” tag) and GUI skin for this particular user

```
  <xsd:complexType name=“userInformation”>
    <xsd:complexContent>
      <xsd:extension base=“cm:genericUserType”>
        <xsd:sequence>
          <xsd:element name=“picture” minOccurs=“0”>
            <xsd:annotation>
              <xsd:documentation>User's picture</xsd:documentation>
            </xsd:annotation>
            <xsd:complexType>
              <xsd:simpleContent>
                <xsd:extension base=“xsd:base64Binary”>
                  <xsd:attribute name=“content-type” type=“xsd:string” use=“required”/>
                </xsd:extension>
              </xsd:simpleContent>
            </xsd:complexType>
          </xsd:element>
          <xsd:element name=“useUm” minOccurs=“0”>
            <xsd:complexType>
              <xsd:simpleContent>
                <xsd:extension base=“xsd:boolean”>
                  <xsd:attribute  name=“umBoxAddressType”
type=“cm:serviceAddressTypes” use=“required”/>
                </xsd:extension>
              </xsd:simpleContent>
            </xsd:complexType>
          </xsd:element>
          <xsd:element name=“guiSkin” type=“xsd:string” minOccurs=“0”>
            <xsd:annotation>
            </xsd:annotation>
          </xsd:element>
          [other elements omitted for brevity...]
        </xsd:sequence>
      </xsd:extension>
    </xsd:complexContent>
  </xsd:complexType>
```

Having described an exemplary input, there follows an example of output components.

Thus, a Java Object Class (see, e.g. 32 in FIG. 3), that represents the extended “user” type and facilitates access to the database is illustrated below:

```
/**
* User type for the Converged Desktop service.
*/
public class UserInformation extends GenericUserType {
    BinaryContent picture;
    String guiSkin;
    boolean isRegistered;
    UseUmType useUm;
    String sipContact;
    String language;
}
```

The specified object class is subject to enhancement, giving rise to JDO 37.

Following, is the database schema (38 in FIG. 3) which was generated for the User object. Note that inheritance is implemented in this case by referring to another table that represents the base type.

As can be seen, the UserInformation Java class persistent fields are mapped into CD_USER Table fields:
The userId persistent field of genericUserType base class is mapped into GENERIC_USER_ID field.
The guiSkin persistent field of UserInformation class is mapped into GUI_SKIN field.
The is Registered persistent field of UserInformation class is mapped into IS_REGISTERED field.
The picture persistent field of UserInformation class is mapped into PICTURE, PICTURE_NULL and PICTURE_TYPE fields.
The sipContact persistent field of UserInformation class is mapped into SIP_CONTACT field.
The useUm persistent field of UserInformation class is mapped into USE_UM, USE_UM_NULL and UM_BOX_ADDRESS_TYPE fields.
The language persistent field of UserInformation class is mapped into LANGUAGE field.

| CREATE TABLE CD_USER | |
|---|---|
| ( | |
| GENERIC_USER_ID | NUMBER, |
| GUI_SKIN | CLOB, |
| IS_REGISTERED | NUMBER, |
| PICTURE | BLOB, |
| PICTURE_NULL | NUMBER, |
| PICTURE_TYPE | VARCHAR2 (255 BYTE), |
| SIP_CONTACT | VARCHAR2 (255 BYTE), |
| UM_BOX_ADDRESS_TYPE | VARCHAR2 (255 BYTE), |
| USE_UM | NUMBER, |
| USE_UM_NULL | NUMBER, |
| LANGUAGE | VARCHAR2 (255 BYTE) |
| ) | |

```
TABLESPACE TAPPS;
ALTER TABLE CD_USER ADD (
  PRIMARY KEY (GENERIC_USER_ID)
    USING INDEX
    TABLESPACE TAPPS;
```

Lastly, in accordance with this example there follows an HTML representation of the generated GUI for a “user” (39 in FIG. 3). This is done using simple XSLT scripts. A sample result is:

```
    <html>
    <head>
    <meta http-equiv=“Content-Language” content=“en-us”>
    <meta http-equiv=“Content-Type” content=“text/html; charset=windows-1252”>
    <title> Define New User </title>
    </head>
    <body>
    <p align=“center”><font size=“5” color=“#0000FF”>Define New User</font></p>
    <table border=“1” cellpadding=“0” cellspacing=“0” style=“border-collapse: collapse”
bordercolor=“#111111” width=“100%” id=“AutoNumber1”>
      <tr>
        <td width=“81%”><input type=“text” name=“T1” size=“73”></td>
        <td width=“19%” align=“left”>
        <p align=“left”>User ID <font color=“#FF0000”>*</font></td>
      </tr>
      <tr>
        <td width=“81%”><input type=“text” name=“T1” size=“73”></td>
        <td width=“19%” align=“left”>ID Number</td>
      </tr>
      <tr>
        <td width=“81%”><input type=“text” name=“T1” size=“73”></td>
        <td width=“19%” align=“left”>Name</td>
      </tr>
      <tr>
        <td width=“81%”><input type=“text” name=“T1” size=“73”></td>
        <td width=“19%” align=“left”>Fax</td>
      </tr>
      <tr>
        <td width=“81%”><input type=“text” name=“T1” size=“73”></td>
        <td width=“19%” align=“left”>Phone 1</td>
      </tr>
      <tr>
        <td width=“81%”><input type=“text” name=“T1” size=“73”></td>
        <td width=“19%” align=“left”>Phone 2</td>
      </tr>
      <tr>
        <td width=“81%”><input type=“text” name=“T1” size=“73”></td>
        <td width=“19%” align=“left”>Email</td>
      </tr>
      <tr>
        <td width=“81%”><input type=“text” name=“T1” size=“73”></td>
        <td width=“19%” align=“left”>Address</td>
      </tr>
      <tr>
        <td width=“81%”><input type=“text” name=“T1” size=“73”></td>
        <td width=“19%” align=“left“>Birth Date</td>
      </tr>
      <tr>
        <td width=“81%”><input type=“text” name=“T1” size=“73”></td>
        <td width=“19%” align=“left”>Gender</td>
      </tr>
    </table>
    <p ><font cotor=“#FF0000”>*</font> denotes mandatory fields.</p>
    </body>
    </html>
```

Which would result in the following very simple Web page:

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The present invention has been described with a certain degree of particularity, but those versed in the art will readily appreciate that various alterations and modifications may be carried out without departing from the scope of the following Claims:

1. A method for generating objects which facilitate access of application platform system and service provisioning system to a shared database, comprising:
generating substantially automatically at least one first object for incorporating in the application platform system;
generating substantially automatically at least one second object for incorporating in the provisioning system;
wherein said first objects facilitate access of the application platform system to the shared database; and wherein said second objects facilitate access of said service provisioning system to said shared database.

2. The method according to claim 1, wherein the at least one first object and at least one second object are identical.

3. The method according to claim 1, wherein said application platform being a service delivery platform (SDP) and wherein said provisioning system includes telecom service management system (SMS).

4. The method according to claim 1, wherein said object is Object Relational (O/R) Mapping.

5. The method according to claim 1, wherein said object implements JAVA Object (JO).

6. The method according to claim 5, wherein said JO being Java Data Objects (JDO).

7. The method according of claim 1, further comprising: generating substantially simultaneously a schema of said shared database and said objects.

8. The method according to claim 1, wherein said objects are generated from a source described in one of XML schema, JAVA class, UML.

9. The method according to claim 3, wherein said generating substantially automatically at least one first includes generating corresponding at least one first object class, and wherein said generating substantially automatically at least one second object includes generating corresponding at least one second object class.

10. The method according to claim 9, wherein said objects are generated from a source described in XML schema and further comprising binding said source giving rise to said at least one first object class and to at least one second object class.

11. The method according to claim 10, wherein said binding is implemented using JAXB technology.

12. The method according to claim 9, wherein said object is generated from said object class using enhancing technique.

13. The method according to claim 12, wherein said enhancing technique is implemented using enhancer tool.

14. The method according to claim 1, wherein said objects are generated in Service Creation Environment.

15. A telecommunications system for facilitating access of service delivery system and service provisioning system to a shared database, comprising:
a generator for generating substantially automatically at least one first object for incorporating in a application platform system and at least one second object for incorporating in a provisioning system,
whereby said first objects facilitate access of the application platform system to the shared database; and wherein said second objects facilitate access of said service provisioning system to said shared database.

16. A method for generating objects which facilitate access of service provisioning system to a database, comprising:
generating substantially automatically at least one object for incorporating in the provisioning system, wherein said objects facilitate access of said service provisioning system to said shared database;
providing a provisioning application for incorporation in the provisioning system; the provisioning application is configured to communicate through provisioning interface with a Web application running on a remote Web server, whereby the Web application is capable of accessing data in the database through the objects;
generating substantially automatically a GUI associated with the Web application.

17. The method according to claim 1, further comprising providing a provisioning application for incorporation in the provisioning system; the provisioning application is configured to communicate through provisioning interface with a Web application running on a remote Web server, whereby the Web application is capable of accessing data in the database through the objects;
generating substantially automatically a GUI associated with the Web application.

18. A method for generating objects which facilitate access of application platform system and service provisioning system to a shared database, comprising:
generating substantially automatically at least one first object for incorporating in the application platform system;
generating access means for incorporating in the provisioning system;
wherein said first objects facilitate access of the application platform system to the shared database; and wherein said access means facilitate access of said service provisioning system to said shared database.

19. The method according to claim 18, wherein said access means being SQL interface.

20. A method for generating objects which facilitate access of application platform system and service provisioning system to a shared database, comprising:
generating substantially automatically at least one first object for incorporating in the provisioning system;
generating access means for incorporating in the application platform system;
wherein said first objects facilitate access of the provisioning system to the shared database; and wherein said access means facilitate access of said application platform system to said shared database.

21. The method according to claim 20, wherein said access means being SQL interface.

22. A program storage device readable by machine, tangibly embodying a program of instructions executable by the machine to perform method steps for generating objects which facilitate access of application platform system and service provisioning system to a shared database, comprising:
generating substantially automatically at least one first object for incorporating in the application platform system;
generating substantially automatically at least one second object for incorporating in the provisioning system;
wherein said first objects facilitate access of the application platform system to the shared database; and wherein said second objects facilitate access of said service provisioning system to said shared database.
